(19) United States
(12) Patent Application Publication
(10) Pub. No.: US 2016/0205893 A1
(43) Pub. Date: Jul. 21, 2016

(54) PORTABLE SOLAR ELECTRICALLY HEATED ANIMAL DRINKING WATER CONTAINER

(71) Applicant: WILLIAM NORMAN SIMMONS, HOLBROOK, NY (US)

(72) Inventor: WILLIAM NORMAN SIMMONS, HOLBROOK, NY (US)

(21) Appl. No.: 14/601,893

(22) Filed: Jan. 21, 2015

(51) Int. Cl. A01K 7/00; A01K 39/02

(52) U.S. Cl. CPC A01K 7/00; A01K 39/02

(57) ABSTRACT

A heated water vessel for providing drinking water for animals is provided which has a single wall container, or a dual wall container both exteriors have polymer plastic/metals/rubber with light reactive materials on the container on each and on the second dual wall polymer plastic with light reactive materials exterior container wherein the second walled container is nested within the first, forming an enclosed air pocket between the first, second container. The second dual two containers are sealed together with a breakable waterproof adhesive in order to allow the separation of the containers if necessary. An electric heating printed coil is printed or sprayed around the outer surface of the second container either side or bottom or both and in contact therewith in order to prevent the water within the inner container from freezing over during subfreezing temperatures. The polymer plastic with light reactive materials are spray on or printed on the exteriors in a form of solar cells, solar cell heat sinks, multi solar cell power generators producing currents from the sun/electromagnet force field currents from the coil of the earth formed into an array. The polymer sets the molecules/atomic structure in alignment making them field directional elements along a surface plane and decreasing the resistance of the electron flow in each element. This process can be done in metals before the structural is formed also in metal mixtures.

### BACKGROUND OF THE INVENTION

A heated water vessel for providing drinking water for animals is provided which has a single wall container, or a dual wall container both exteriors have polymer plastic/metals/rubber with light reactive materials on the container on each and on the second dual wall polymer plastic with light reactive materials exterior container wherein the second walled container is nested within the first, forming an enclosed air pocket between the first, second container. The second dual two containers are sealed together with a breakable waterproof adhesive in order to allow the separation of the containers if necessary. An electric heating printed coil is printed or sprayed around the outer surface of the second container either side or bottom or both and in contact therewith in order to prevent the water within the inner container from freezing over during subfreezing temperatures. The polymer plastic with light reactive materials are spray on or printed on the exteriors in a form of solar cells, solar cell heat sinks, multi solar cell power generators producing currents from the sun/electromagnet force field currents from the coil of the earth formed into an array. The polymer sets the molecules/atomic structure in alignment making them field directional elements along a surface plane and decreasing the resistance of the electron flow in each element. This process can be done in metals before the structural is formed also in metal mixtures.

The necessity for providing drinking water to animals cannot be understated. Animals must have water in order to survive and to assist in converting solid feed into usable products like hay and gains and feeds for providing metabolizable energy of feed ingredients energy to all the animals.

In farming situations, water is generally fed to animals in the out-of-doors or in an open-air building, such as a livestock pavilion or a barn. When the air temperature is below freezing 32 degrees and the water in this environment will eventually freeze, preventing access to the water.

To enable an animal in this situation to have water, the prior or standard practice has been to break the ice cap on the surface of the water in order to gain access and most animals do not like frozen ice.

Generally, the animal will nudge its nose against the ice to break it. Unfortunately, this practice must be maintained at a regular interval in order to prevent the ice cap from becoming too thick from haft an inch to two inches within an hour or less. In such situations, the animal will not be able to break the ice without, assistance. This requires the time of a person to constantly monitor drinking vessels during subfreezing temperatures breaking them and refilling them with water.

In order to solve this dilemma, it has been the practice to provide an electrically heated container, which will maintain the water at above-freezing temperatures but this adds additional costs in manpower and energy costs. Examples of such drinking vessels are as follows:

U.S. Pat. No. 1,033,799 to Harvey is directed to an electric water heater, which comprises an outside base member and an inside vessel. Situated within the vessel is a high-resistance heating coil enclosed in insulation. Additionally, there is a circuit breaker to maintain the temperature of the water.

U.S. Pat. No. 2,665,366 to Cleveland is directed to an open vat, which is electrically heated to provide water for animals. A continuous length of heating wire is passed around the bottom of the vat over positioned rods in order to form a series of closely arranged loops. The wires keep the contents of the vat thawed.

U.S. Pat. No. 3,648,659 to Jones is directed to an electrically heated bird bath, in which a heating unit is mounted in a recess next to bowl of the bird bath.

U.S. Pat. No. 3,820,508 to Robinson is directed to a portable drinking bucket, specifically intended for a horse. The bucket contains an inner container and an outer container. An electric heating means is disposed between the inner and outer container. Insulation is provided around the heating means.

U.S. Pat. No. 4,640,226 to Liff is directed to a water apparatus containing spaced inner and outer walls. Situated between the walls is an electric heating means to keep the water device from thawing. The electric heating wires are coated with an insulation material.

U.S. Pat. No. 4,320,721 to Silcox is directed to an animal watering apparatus which includes an inner and outer wall, between which is placed an electric heating element. The electric heating element is disposed between insulation.

U.S. Pat. No. 4,908,501 to Morris is directed to an animal watering apparatus which includes an inner and outer wall, between which is placed an electric hard wired cable coil heating element connecting clips to the inside vessel. The electrical heating cable has a detachably connected electrical cord covered with chewable resistance material. The electric heating is disposed between two rubber buckets with air spacing.

U.S. Pat. No. 5,028,760 to Okuyama is directed to an infrared electrical panel heater includes an open side cover by a sintered electroformed porous metal panel. An electric sheathed heating element is installed in housing in contract with the inner surface of the porous panel.

U.S. Pat. No. 5,592,647 to Yamauchi is PTC panel heater with small rush current characteristic and highly heat insulating region corresponding to heater location to prevent local overheating.

U.S. Pat. No. 6,134,386 to O'Donnell is a panel heater for animal use generally rectangular slab like shape. The panel heater has sloping sides to accommodate animals and comprises basically a shell into which a fire retardant material is poured around electrical resistance wires.

U.S. Pat. No. 6,151,448 to Reusche this direct electrical heater for livestock is installed though the drain plug opening of a water tank. The apparatus heater includes a power cord interconnected with a heating element though a temperature control device for delivering electrical power to the heating element in a controlled fashion for livestock water tank.

U.S. Pat. No. 6,707,988 to Reuche this electrical apparatus water heater is for the use with livestock, water tank including a heating element, a housing including a drain plug fitting, and a power cord. The power cord is interconnected with the heating element though a temperature control device (a thermostat) for the delivering electrical power to the heating element in a controlled fashion for livestock water tank.

The Heated Water Bucket at Amazon online, 1.5 gal to 5 gal by API & Farm Innovators & Allied Plastic, is directed to a heated water bucket, which is disclosed as maintaining automatic temperature control. The inner bucket is plastic or rubber or stainless steel or recyclable plastic with the electrical heating coil on the bottom of the buckets.

It has been found that many of these containers suffer from a variety of disadvantages. For example, the containers may be too large to allow easy portability. Therefore, the drinking vessel must be “permanently” placed at one location. This has the disadvantage of not allowing easy portability of drinking water to animals which may remain in sub-freezing temperatures, but out of the range of a drinking vessel. In order to compensate for this, a person must then bring the animal to the drinking water and animals at these temperatures do like to move.

An additional deficiency is that many of the drinking containers of the prior art have exposed wiring or exposed heating elements, which may either cause burns or electrical shock to the animal. If the animal can get to the electrical wire or cable they will chew it. So now they go to bottom water heater but there are problems with them. Should this occur, the animal may become frightened of the vessel and refuse to go near it thus defeating the entire purpose of the apparatus.

The heating of the elements causes water in the air to condense on the insulation. In subfreezing weather, the condensed water on the regions of the fiberglass or form insulation farthest from the heating elements will freeze. The freezing effect will cool the water container thus requiring more heat energy output from the heating elements.

So the best solution would be the small portable solar water heater without the wiring or electrical cords and the energy cost for operating the farm or barn go down at about 45 watts per unit and your profits go's up.

### SUMMARY OF THE INVENTION

It is therefore an object of the present invention to provide a solar heated water container with solar cells, solar heat sinks cells, multi solar cell power generators with a printed electrical or a combination of a thermo heat pump cell with the solar cell or both which increases the function ability over the standard electrical heated buckets which obviates the above-mentioned disadvantages.

It is also an advantage of the present invention to provide a solar cell/thermo heat sink cell/multi solar cell power generator into an array into a coil to heat the water container, which is self-contained, easily portable, and prevents water from freezing at temperatures down to −25.degree. F.

The multi solar cell power generator is a dual source product from the solar cell is working off the energy of the sun the photons and the solar EMF coil generator is also working off the electromagnetic energy of the earth spinning though the force fields. It's like putting a coil on the exterior of a spinning armature of an electric motor, and each time it hits a electromagnetic wave it generates a electric flow in the coil.

These and other objects of the present invention are defined by a portable solar drinking apparatus comprising a first or exterior container with a solar cell array on it with polymer directional current atoms locking into a permanent direction of the electromagnet force fields with the force fields, and electron fields having a first upper edge, a first side wall and a first bottom wall with same structure printed or painted on, and a second or interior container having a second upper edge, a second side wall with a solar cell array on it with polymer directional current atoms locking into a permanent direction of the electromagnet force fields with the force fields, and electron fields and a second bottom wall, wherein the second side wall has an exterior surface and an interior surface.

The second or inner container is made of polymer plastic, which is safe and for the animals. Both containers are aligned by male/female slot's in the tops and as you snap together the your top and bottom vessels your form an electrical surface to surface connection between the solar cell exterior wall and the interior printed coil heater. The inner container preferably has smooth, roll-over edge. The second container is nested in spaced relationship within the first container.

The spaced relationship creates an enclosed uninterrupted air pocket that the thermo heat can work creating primary and secondary elements between the interior side walls of the first container and exterior walls of the second container. As your running printed duel coils from the bottom of the second container bottom up and around the exterior of the second container. The drinking container also includes an electric solar heating means starting from the solar cell heat sinks, solar cells, an multi solar cell power generators the center point coiling around the bottom, extending along the outer surface of the second side wall vessel. The heating means is a primary a printed heating coil wire or painted on the bottom and exterior of the second vessel attached to the inner polymer plastic pail, with a secondary solar heating element sink that provides a secondary heating element. Both provide a necessary “safety” element because the printed or painted on cable is conduct electricity through the polymer plastic solar cells on the exterior of the vessels.

By avoiding insulation and wiring cables & clips, the manufacturing process is simplified. The simplification on the manufacturing by using either printed cells or spray on cells the side of the thickness decreases and you layer the structures on the molecules/atomic structures of laying atoms by printing or by larger layers by painting and the bonding between structures is electromagnetic charges, therefore once you put it together it stays together. The expense of creating hard wiring the container is reduced but your profit margins are increased and the cost of the present invention is reduced.

The portable solar drinking container is preferably provided with a heavy-duty bail or handle, thus making it easily portable and with the horizontal slot the heavy duty bail can slide. Further objects, features and advantages of this invention will be apparent from the following detailed description when taken in conjunction with the accompanying drawings.

### BRIEF DESCRIPTION OF THE DRAWINGS

FIG. 1 a perspective view of the portable solar drinking container single wall of the present invention with the printed or painted exterior polymer coating of solar cells, solar heat sink cells, multi solar cell power generators in an array.

FIG. 2 is a partial cross-sectional, side elevated view of the portable drinking container dual wall of the present invention also includes printed or painted exterior polymer coating.

FIG. 2A is a cross section interior of a dual wall container

FIG. 3A is a surface view of the Circle with a circle solar cells part of an array.

FIG. 3B cross-sectional view of a portion of a dual wall taken along lines 3B-3B of FIG. 2, showing the joint of the two containers and the connection of solar cells to the heating coil.

FIG. 4 cross-sectional view of a portion of a single wall taken along lines 4-4 of FIG. 3A. of the directional polymer sandwich design of the N Type & Junction & P Type polymer with light reactive material

FIG. 5 a perspective view of the portable solar drinking container dual wall of the present invention with the printed or painted exterior polymer coating solar cells

FIG. 6 a perspective surface view of the portable solar drinking container duel wall print or paint on the exterior surface with the vertical lines connecting the solar cells array of the present invention

FIG. 7 is a partial cross-sectional, side elevated view along line FIG. 6. the multi solar cell power generator showing the cross section with the coil that generates the current by the earth cutting though the electromagnetic force fields of this planet.

FIG. 8 Is a three dimensional view of a solar cell array and showing the unit of a solar cell.

FIG. 9 Is a cross sectional view with four layers of cladding materials and their relationship To each other.

### DETAILED DESCRIPTION OF THE INVENTION

Reference is now made to the drawings, wherein the same numbers will be given to similar features throughout. Referring now to the figures, there is disclosed the drinking containers 20 & 40/19 of the present invention. The drinking container 40 is a bucket or pail-shaped container suitable for holding a liquid or warm feed mix but preferably water. The drinking container wall 18 includes an exterior or first container 40 and an interior or second container 19. A bail or handle 27 is rotatable connected to upwardly projecting polymer plastic loops 39 build in the side of the container with side cut horizontal slits 28 so the metal hand 27 can roll along them the ears 39, which extend along the top of the second container 19.

The first container 40 include a downwardly depending side wall 18, a bottom and an upper edge or lip 26. It is preferred to mold the first container 20 in a single piece, on the duel wall vessel there is an alignment piece male/female 13 molded into the bottom of the lip and top of the container this align both containers together also forming the electrical solar cells to the interior printed electrical coil around the exterior 36 of the second vessel and it has dual coils on the bottom of the first container 11 and the bottom of the second container 11. The first container 40 is preferably made of a high impact polymer plastic material to protect the water drinking container during normal use. It is expected that the drinking container 20 & 40/19 will receive harsh treatment in farm-type settings. For example, it is foreseeable that the drinking container 20 & 40/19 will be banged around during the filling process and kicked by animals when it is placed in a livestock pen.

Therefore, the entire container should be made of a polymer plastic material sufficient to withstand such abuse. One such material is galvanized steel, preferably 24-32 gauge and hot dipped galvanized steel, but galvanized steel will get dent as horses, cattle, and other animals will step on the buckets. A preferred outer material is high impact polymer plastic, which will not only withstand abuse, but will be less inclined to deform or be dented. Additionally, by utilizing polymer plastic as an outer and interior material, the bucket will be conductive directional electrical charges but the amperage is very low and safer for animals.

The first single wall container 20 is preferably a single piece of polymer plastic with upwardly projecting polymer plastic loops 39 build in the side of the container with side cut horizontal slits 28 so the metal hand 27 can roll along them the ears 39, with the step up or recessed bottom 45. An example of a preferred second container 40/19 is described in several patent and which is incorporated herein by reference for a description of the second container. The second container construction is preferably of a non-porous polymer plastic, which resists the effect of heat and cold and is easy to clean. It is preferred that the second container 19 be made of a one-piece molding and have no corners to trap dirt, no seams to split and edges rounded for safety. The second container 19 includes a side wall 22, a step up recessed bottom 45 and a “roll-over” rim 25.

The single wall container having an upper edge 26 and a side wall 21 with a design of a circle thermo heat sink within a circle printed FIG. 3A or spayed or any other design FIG. 4 and FIG. 7 with lip 25 and rolled down edges 26 with dual rollers 27 into slotted anchor sides 28.

The structural surface of the single walled has several layers of charged directional polymer print 21 or spray on exterior face of the vessel 21, wherein it has a charged subsurface by having a directional electrical current running on the polymer set all the molecules/atomic structure in current alignment 21.

This becomes a solar cell with a thermo heat sink in the center FIG. 3A, wherein creating the current of the-type polymer material or any other kind of material that can hold, or fix the alignment of material in it or around it FIG. 4 & FIG. 7

This clear polymer coat on top like a donut 23 & 24 with a top n-type polymer 42 electron flow material, a junction 43 to collect the photons in the middle, and a with p-type semiconductor polymer 44 materials with the center of the donut filled with a highly resistance polymer 14 center which has direct contract with the outside single wall container 21 this produces the solar cell with a thermo heat sink that heats the center point, the heat and solar charges are encapsulated by the clear polymer coating to seal the multi-layer waffle design polymer that has the directional flow light material locked in.

This low temperature solar cell a thermo heat sink FIG. 3A is heating the water by thermo conductivity the heat is generated by the solar thermo heat sink created by the solar cell itself but can be linked/printed wired into solar cell generators that produce both solar and electromagnetic energy sources that are on the outside of the vessel 21/22.

This mixed of polymer ratio, with the size of the print and the micron size of light materials added or decrease you can change the output voltage of each solar cell by the polymer ratio to light material in the print or spray on surface of the vessel 21

The second container has a dual wall with an interior container having a second upper edge, a second side wall and a second bottom wall, wherein the second side wall has an exterior surface and an interior surface, the second side wall being made of polymer plastic FIG. 2, wherein the second container is nested in spaced relationship within the first container such that the second upper edge comprises a roll-over rim which extends over the first upper edge, wherein the spaced relationship creates an enclosed uninterrupted air pocket 29 between the side walls and bottom walls of the first and second container, wherein the first and second container are nested together in sealing engagement, and wherein the first and second containers are sealed together by a waterproof nonporous adhesive 41.

The first wall container having an upper edge, a side wall with a design of a circle within design heating element within it with parallel lines running top to bottom or a circle within a circle design with parallel lines running top to bottom printed or spayed or any other design.

That becomes each different solar cells creating the current running on both sides of this-type polymer FIG. 3B to the top of the top and over the upper edge 32 and running on the inside down 32 the integrates to the exterior wall 35 wherein of the interior side container 32 the second fix the alignment of material 13.

With a clear polymer coat on top like a donut FIG. 7 with a top n-type polymer electron flow material 42, a junction to collect 43 the photons in the middle, and a with p-type semiconductor polymer material 44 with the center of the donut has a coil polymer center 33 which has direct contract with the outside dual vertical lines running to the top of the vessel 34 on the outside of the first wall of the dual wall container,

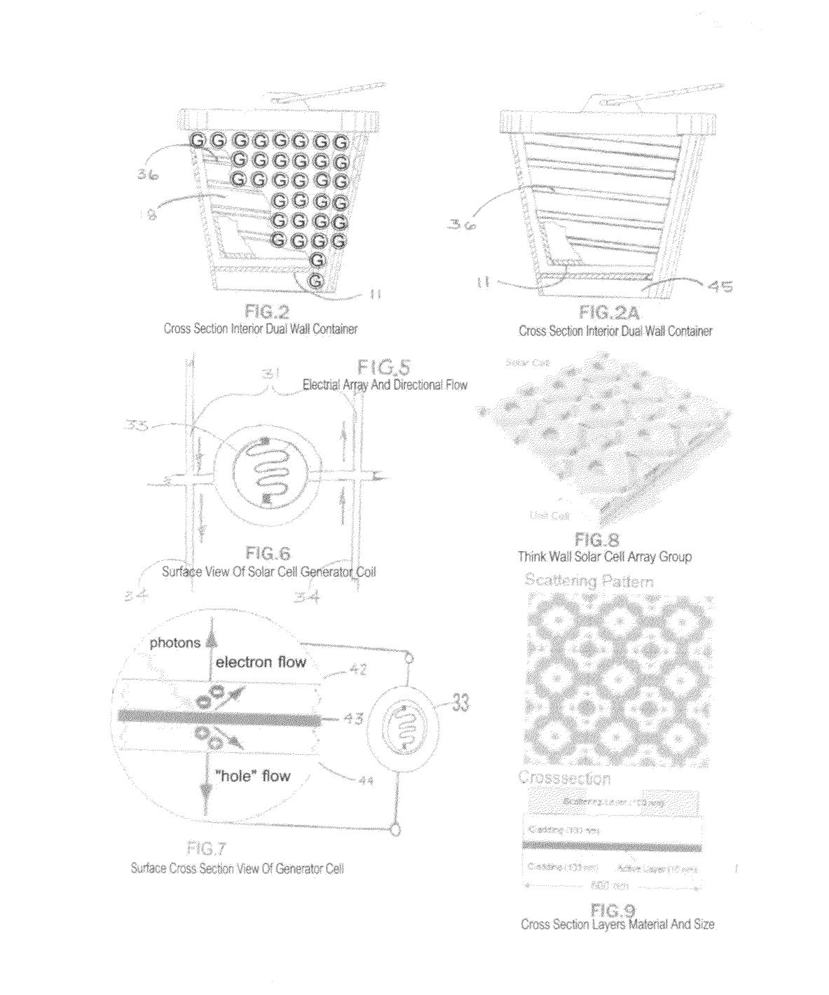

This low temperature solar cell with a thermo heat sink heat coils FIG. 3A is heating the water by thermo conductivity the heat is generated by the solar cell heating the exterior shell, linked solar cell generator FIG. 6 and the air pocket 29 of within and the second coils on the second container exterior 36, running down to the bottoms 11 is heating the water within 37.

An electric heating large polymer print 36 or spray is wrapped around the exterior surface of the second side wall 38 with the coil s on the bottom of both containers 11 and in contact there with them provides heat to the vessel and a secondary heat pocket is thermo heating the air between them 29.

The portable solar heat able water vessel further comprising a handle attached to the roll-over rim 25 of the second interior container 19.

The portable heated water vessel of the handle is attached to the roll-over rim by two upward extending metal loops 27 passing through a heavy duty polymer plastic ears 39 provided in the roll-over rim, the metal loops being connected to a heavy plastic slots 28 extending along the sectional circumference of the second container below the upper edge of the second container. The portable heat able water vessel the electric heating coils/cells on the walls & bottoms are held outside contact with the outer surface of the second side wall by means of printed on or painted on design elements and electromagnetic charged subsurface.

The portable heat able water vessel the waterproofing adhesive 41 sealing together the first and second containers is a silicone waterproof base adhesive 41 and forms the connection of the solar cells and duel line coil heating lines FIG. 3B printed on the exterior of container and the bottom of both vessels 11.

The roll-over rim comprises an outwardly extending surface FIG. 3B and a downwardly extending surface. In the annular space defined by the outwardly extending surface 25 and the downwardly extending surface, a heavy polymer plastic ring may be designed which extends along the circumference of the upper edge of the second container below the outwardly extending surface a junction of both rims.

The heavy polymer plastic ring forming the two upwardly extending loops 39, which pass through slits provided in the outwardly extending surface 25 to allow for the attachment of the handle 27. The handle 27 is a heavy-duty handle, preferably made of steel, for carrying or attaching the drinking vessel 39 to a support clip or ring on the wall or metal fence or wood rail fence.

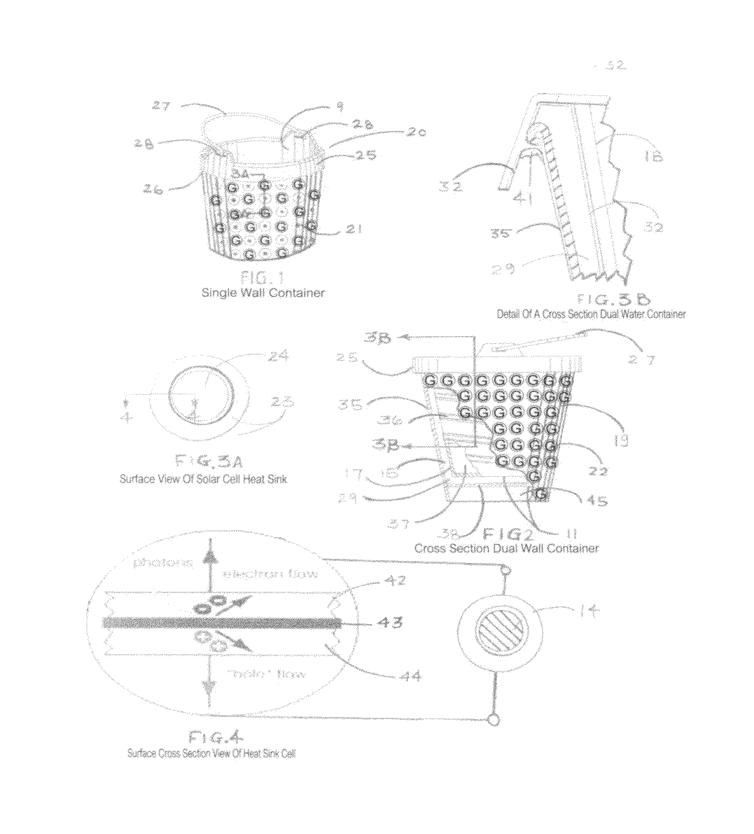

The preferred construction of the second container 19 is that of heavy polymer plastic. Heavy polymer plastic has been found to be safer to use in a drinking vessel due to by utilizing polymer plastic as an outer and interior material, the bucket will be conductive directional electrical charges but the amperage is very low and safer for animals. But with the encapilization of the low voltage heating the water and is environmental helpful in on saving oil & coal and cutting down the pollutions that you breathe air into your lungs each day. Additionally, it is preferred that the color of the polymer have black light materials in order to absorb solar heat to more efficiently and effectively warm the contained liquid but it really doesn't matter only the sub structuring of wafer materials in alignment in the polymer The term “portable” is intended to define a drinking container, which can be carried from one location to another with some ease. Preferably, the drinking container 20 & 40 of the present invention will be easily portable by one person. In this manner, it is within the scope of the present invention to define the drinking container 20 & 40 to be a vessel having a capacity of 3 gallons to 5 gallons of water, although the vessel may be larger or smaller as required. Referring now to FIG. 1 and FIG. 2, there is provided an electric solar cells in polymer structure in an array and the solar thermo heat sinks polymer structures, multi solar cell power generators by means in the form of a printed or painted heating coil on the surface of the exterior 20 & 40 which is helically printed on the exterior of vessel two on the outer surface 21 & 22 & 32 of the side wall 21 & 22 of the second container 32. The present day solar heating cells will operate on an electric current of about 600 m ample with 10 to 13 watts per square foot with an efficacy between 11% to 14% with a standard manufacture 5 gallons, holds 5.86 gallons of water, with a. height of 15.6 inches with a circumference top of 37.1 inch and a bottom circumference of 32 inches or about 3.7 square feet which will produce about 37 to 48 watts of power with the old standard design of today's solar cells.

Using the standard electrical coil per U.S. Pat. No. 4,908,501 by Morris which provides 3 watts heat output per foot of cable times 15 feet the power is 45 watts. By locking in the alignment of the polymer with the light materials molecules/atomic structure level with the polymer plastic sandwich level design cutting down the resistance to the flow you increased efficacy of my solar cell design the 3.7 square feet would produce over 300 watts of power or 555 B.T.U or about 80 to 110 watts per square foot or more power. This process can be done in metals before structural forming into a shape on an atomic structure alignment of the atoms directionally within the molecule of the metals also in metal solar cells to form solar cells, cell heat sinks, and multi solar cell power generators. In today's process of laying atoms/molecules now you can freeze the direction of the flow of the currant as the structure cools into its final shape.

By using the coil design, you cut the EMF or electromagnetic force field of this planet 24,902 miles as your moving at 1,037.5 MPH thereby creating a multi solar power electromagnet generators of electricity in each cell on the surface area of the object which would add additional output by the speed this planet is moving across the EMF fields that this planet generates we get addition electromagnetic power from the speed from our coils as they cut the electromagnet force fields of this planet.

The heating solar printed cable 36 is preferably printed around the outer surface 32 and the bottom 11 of the second container FIG. 2 approximately 8 to 12 revolutions, exiting at the bottom of container 40 bottom 11 to the top of the outer pail. Of course, it is within the scope of the present invention to provide more or fewer revolutions of the heating printed coil cable around the container 36 as needed, depending upon the climate conditions.

Referring now to FIG. 1 and FIG. 2 and FIG. 5, the construction of the vessel 20 & 40 & 19 of the present invention will be described. Prior to nesting the second container 19 within the first container 40, the electric heating printed cable 36 must be attached to the outer surface 18 of the second container 19. The electric heating printed cable 36 is the printed on the outer surface 18 of the second container 19 via the electron charge on the surface by the D.C direct low voltage current. The heating printed cable is around the second container 19 in an upward direction starting at the center bottom in a fashion as illustrated in FIG. 2.

The end of the dual heating cable is connected to the bottom center running in a coiling manner FIG. 2 on the center up the exterior walls to connected to the electric solar cells on the exterior sides is positioned near or on the adjacent upper rim which they are locked in by the jointing of both containers FIG. 3B. In this manner, the second container 19 is provided with an electrically solar heated system which will prevent the contained liquid from freezing in subfreezing temperatures.

The second container 19 and the first container 40 are then nested together with the roll-over rim FIG. 3B of the second container 19 enclosing the upper, lip of the first container 40. The second container 19 and the first container 40 are then sealed at the location, where the upper lip meets the inner surface of the downwardly extending portion 26 of the rim FIG. 3B. Although there are a variety of methods to seal the pails together, a preferred sealant is a waterproof silicone sealant 41, which is a nonporous sealant, thus preventing air or liquid from traversing the sealed location 32 top. Should the heating printed cable 36 malfunction, it can be relatively easily replaced by breaking the silicone seal, separating the containers 19 & 40, and replacing the old printed heating cable with a new printed patch heating cable and then reseal the containers together with waterproof silicon seal 41.

The union of the two containers 19, 40 makes the drinking container 19 a singular unit and defines an air pocket 29 between the first container 40 and the second container 19. The air pocket 29 preferably extends along the sides and bottom of the drinking container 19.

You will find there isn't anything to discourage animal chewing and to protect the animal from electric shock you cut down the amperage and if you look at the buckets in a barn must of them the animal chews the top or lip for something to do.

In this manner, water may be conveniently disposed within the inner surface 37 of the second container 19. The drinking container 40 may then be transported via the handle 27 to the desired location. In subfreezing temperatures, so which activation of the sun that produces the photons that activates the solar heat sinks/multi solar cell power generators that work off the electromagnetic force fields of this planet that produces a second energy power that produces the scalar array of free electrical power that heats the electric printed heating coil cable 36 to heat the inner surface 32 of the second container 19. In this manner, the water will remain free from icing over while it is in the vessel 40. Further, due to the composition of the second container 19 and the heating printed coil cable 36, there is substantially no chance of creating an electric shock to the user animal.

Further still, the overall engineering design of the size of the cells, solar heat sinks cells, multi solar cell power generators will control the heating producing elements by the portable solar heated animal drinking water container adapted to its surface area to prevent the vessel 20 & 19 from overheating.

It is an added and unexpected advantage of the present invention that the air pocket 29 is not provided with any foamed insulation or any other insulating materials. It has been found that the presence of insulation reduces the efficiency of the drinking container 19 by creating condensation and ice in the “air pocket” area 29. Frost may then appear on the exposed inner surface 15 of the second container 19 where there is no water. You could add a power cable at the bottom to run low powered lights this depends on size and shape of the container.

It is understood that the invention is not confined to the particular construction and arrangement herein illustrated and described, but embraces such modified forms thereof as come within the scope of the following claims.

### DRAWING TABLE OF SECTIONS

### Brief Description of Each Section Page 11 and Page 12

FIG. 1 Single Wall Container

FIG. 2 Cross Section Dual Wall Container

FIG. 3A Surface View of Solar Cell Heat Sink

FIG. 3B Detail of a Cross Section Dual Water Container

FIG. 4 Surface Cross Section View of Heat Sink Cell

FIG. 5 Electrical Array and Flow

FIG. 6 Surface View of Solar Cell Generator Coil

FIG. 7 Surface Cross Section View of Generator Cell

FIG. 8 Think wall Solar Cell Array Group

FIG. 9 Cross Section Layers materials

1. A portable heat able water vessel for providing drinking water for animals, adapted to prevent water from freezing at temperatures to −25.degree. F., the water vessels comprising:
(a) the single wall container having a upper edge, a side wall with a design of a circle within a circle printed or spayed on sides & coil bottom; solar cells, thermo heat sink cells, multi solar cell power generators or any other cell design in a scalar array, or mixture of claim 1 wherein;
(b) the structural side bond of several layers of charged polymers has a base print or spray on claim 1 wherein it has a charged by having a directional electrical current running on the polymer set, or metal all the molecules/atomic structure in current alignment of claim 1 wherein; (c) that becomes a solar thermo heat sink cell of claim 1 wherein creating the current of the-type polymer materials and or metal or any other kind of materials that can hold and or fix the alignment of material in it or around it into alignment structure bond of claim 1 wherein;
(d) a clear polymer coat on top of the cell pattern design; like a donut with a top n-type polymer electron flow material, a junction to collect the photons in the middle, and a with p-type semiconductor polymer material with the center of the donut filled with a highly resistance polymer center of wherein which has direct contract with the outside single wall container the thermo cell interior generated a heat sink transfer to the direct contact heating it claim 1;
(e) this low temperature solar thermo heat sink cell is heating the water by thermo conductivity the heat is generated by the solar thermo heat sink cells also linked to the multi solar cell power generators that both created the energy by the solar cells/electromagnet force field currents from the coil of the earth formed into a scalar array. of claim 1 wherein;
(f) type polymer with a volume amount of light materials changing the output of the cell by the size and size of the microns materials that you put into the polymer ratio in printing or spray on surface on the exterior or interior of the surface area claim 1 wherein;
(g) this solar cell array works on the principle of energy created by the sun and the energy created by the electromagnetic force fields of this planet as it rotates though its own force fields with the design of the coil claim 1, the structuring of removing most of the electrical resistance in the light materials due to the polymer or metal or any other form of materials that can hold the alignment of the molecules/atomic structures in place by the light direct electrical currency in place to product a higher efficacy solar cell within wherein the solar cell itself claim 1.

2. The second container has a dual wall with an interior container having a second upper edge, a second side wall and a second bottom wall, wherein the second side wall has an exterior surface and an interior surface, the second side wall being made of polymer plastic or metal or rubber wherein the second container is nested in spaced relationship within the first container such that the second upper edge comprises a roll-over rim which extends over the first upper edge, wherein the spaced relationship creates an enclosed uninterrupted air pocket between the side walls and bottom walls of the first and second container, wherein the first and second container are nested together in sealing engagement, and wherein the first and second containers are sealed together by a nonporous breakable waterproof adhesive; and
(a) the first wall container having a upper edge, a side wall with a design of a circle within design heating element within it with parallel lines running top to bottom or a circle within a circle design with parallel lines running top to bottom printed or spayed or any other design;
(b) the structural side bond of several layers of charged polymers has a base print or spray on it that is charged by having a directional electrical current running on the polymer set all the molecules/atomic structure in current alignment sets within the atomic structure of molecule's in alignment making them field directional elements of claim 1 wherein; (c) along a surface plane and decreasing the resistance of the electron flow; that becomes each different solar cell scalar arrays creating the current running on both sides of the-type polymer to the top of the container and over the upper edge and running on the inside down the exterior as the interior center of the cell heats up by the resistance increases so the excess electrical energy current runs to the path of least resistance the parallel lines to heat the center bottom coil claim 1 and also the exterior wall coil claim 1 wherein;
(d) a clear polymer coat on top like a donut with a top n-type polymer electron flow material, a junction to collect the photons in the middle, and a with p-type semiconductor polymer material with the center of the donut filled with a design of the heating coil polymer center which has direct contract with the outside dual wall container of claim 1 wherein;
(e) this low temperature solar thermo heat sink heat coils is heating the water by thermo conductivity the heat is generated by the solar thermo heat sink centers heating the exterior shell and the air pocket and the second bottom coil on the second vessel exterior is heating the water within of claim 1 wherein;
(f) an electric heating large polymer printed coil or spray is wrapped around the exterior surface of the second side wall. bottom and in contact with the surface to provide heat to the vessel and a secondary thermo coil heating the air at the bottom between them claim 1 wherein.

3. The portable solar heater able to heat the water vessel of claim 1 further comprising a handle attached to the roll-over rim of the second interior container.

4. The portable heated water vessel of the handle is attached to the roll-over rim by two upward extending metal loops passing through a slits provided in the roll-over rim, the metal loops being connected to a heavy plastic roll along slots extending along the sectional circumference of the second container below the upper edge of the second container claim 1 therein.

5. The portable solar heat able water vessel the electric heating printed coil is held outside contact with the outer surface of the second side wall by means of structure of the design elements of claim 1 wherein.

6. The portable solar heat able water vessel of the adhesive waterproof sealing together the first and second containers is a silicone waterproof base adhesive.

7. The portable solar heating element wherein the heating coil print is self-regulating by the design, size of print, and material mixtures.

8. The portable drinking vessel the electric heating elements is connected to the rim and sections of the solar cells can be damaged but will keep on working, as the drinking vessel is designed into a scalar array of solar cells as they are damaged the power is rerouted claim 1
